(19) United States
(12) Patent Application Publication
(10) Pub. No.: US 2018/0122563 A1
(43) Pub. Date: May 3, 2018

(54) ELECTRONIC COMPONENT

(71) Applicant: Murata Manufacturing Co., Ltd., Kyoto-fu (JP)

(72) Inventors: Kouhei MATSUURA, Nagaokakyo-shi (JP); Keiichi TSUDUKI, Nagaokakyo-shi (JP); Minoru MATSUNAGA, Nagaokakyo-shi (JP)

(73) Assignee: Murata Manufacturing Co., Ltd., Kyoto-fu (JP)

(21) Appl. No.: 15/788,158

(22) Filed: Oct. 19, 2017

(30) Foreign Application Priority Data
Oct. 31, 2016 (JP) 2016-213613

(51) Int. Cl. H01F 27/29; H01F 27/28; H01B 1/02; H01F 27/24

(52) U.S. Cl. CPC H01F 27/29; H01F 27/2804; H01F 2027/2809; H01F 27/24; H01B 1/02

(57) ABSTRACT

An electronic component includes a body containing glass, external conductors including a first external electrode and a second external electrode each disposed on an external surface of the body, a spiral conductor within the body, and extended conductors including a first extended conductor and a second extended conductor each disposed within the body. One end portion of the spiral conductor is electrically connected to the first external electrode with the first extended conductor therebetween and another end portion is electrically connected to the second external electrode with the second extended conductor therebetween. The spiral conductor contains Ag and at least one oxide selected from the group consisting of Al₂O₃, SiO₂, ZnO, TiO₂, and ZrO₂, and the extended conductor contains Ag, but none of Al₂O₃, SiO₂, ZnO, TiO₂, and ZrO₂.

### CROSS REFERENCE TO RELATED APPLICATIONS

This application claims benefit of priority to Japanese Patent Application 2016-213613 filed Oct. 31, 2016, the entire content of which is incorporated herein by reference.

### TECHNICAL FIELD

The present disclosure relates to an electronic component.

### BACKGROUND

Electronic components each including a spiral-shaped conductor (spiral conductor) and an extended conductor that contain Ag and are disposed within a body containing glass have been proposed. Among those electronic components, a number of components that may increase reliability of connection with external electrodes without compromising reliability in insulation have been proposed (for example, Japanese Unexamined Patent Application Publication No. 2013-135109).

Japanese Unexamined Patent Application Publication No. 2013-135109, for example, discloses a common mode noise filter including a multilayer body having a plurality of insulating layers stacked, an external conductor on the external surface of the multilayer body, and a first coil and a second coil within the multilayer body. In this common mode noise filter, the first and second coils each include a spiral-shaped conductor and an extended conductor connecting the spiral-shaped conductor with the external conductor. According to Japanese Unexamined Patent Application Publication No. 2013-135109, the reliability of connection between the spiral-shaped conductor and the external electrode in the common mode noise filter (or common mode choke coil) can be increased by forming the extended conductor to have a thickness larger than the thickness of the spiral-shaped conductor. The insulating layers of the multilayer body are made of an insulating material containing glass.

In electronic components such as common mode choke coils including an Ag-containing spiral-shaped or extended conductor on a glass-containing insulating layer, the Ag in the conductors is likely to diffuse into the glass by firing in the manufacturing process of the electronic component. This is a cause of initial problems with insulation reliability, such as a decrease in insulation resistance (IR). On the other hand, if Ag diffusion is prevented, connection reliability between the extended conductor and the external conductor is decreased.

### SUMMARY

Accordingly, the present disclosure provides an electronic component having high connection reliability, in which Ag diffusion into glass caused by firing is reduced in the manufacturing process even though the spiral-shaped conductor and the extended conductor disposed on the glass-containing insulating layer contain Ag.

According to preferred embodiments of the present invention, there is provided an electronic component including a body containing glass, external conductors including a first external electrode and a second external electrode each disposed on an external surface of the body, a spiral conductor disposed within the body, and extended conductors including a first extended conductor and a second extended conductor each disposed within the body. One end portion of the spiral conductor is electrically connected to the first external electrode with the first extended conductor therebetween and another end portion of the spiral conductor is electrically connected to the second external electrode with the second extended conductor therebetween. The spiral conductor contains Ag and at least one oxide selected from the group consisting of Al₂O₃, SiO₂, ZnO, TiO₂, and ZrO₂, and the extended conductors contain Ag, but none of Al₂O₃, SiO₂, ZnO, TiO₂, and ZrO₂.

Further, the electronic component may be as follows:

(1) The body may include a plurality of insulating layers stacked.

(2) The spiral conductor may be disposed on an insulating layer different from an insulating layer on which the first extended conductor and the second extended conductor are disposed.

(3) The electronic component may have the structure in which the external conductors include a third external electrode and a fourth external electrode each disposed on an external surface of the body, the spiral conductor includes a first spiral conductor and a second spiral conductor disposed on different insulating layers within the body, and the extended conductors further include a third extended conductor and a fourth extended conductor disposed within the body. One end portion of the first spiral conductor is electrically connected to the first external electrode with the first extended conductor therebetween and another end portion of the first spiral conductor is electrically connected to the second external electrode with the second extended conductor therebetween, and one end portion of the second spiral conductor is electrically connected to the third external electrode with the third extended conductor therebetween and another end portion of the second spiral conductor is electrically connected to the fourth external electrode with the fourth extended conductor therebetween. The second spiral conductor is disposed on an insulating layer different from an insulating layer on which the third extended conductor and the fourth extended conductor are disposed. The first spiral conductor and the second spiral conductor are magnetically coupled to each other.

(4) The first to fourth extended conductors may be disposed on the same insulating layer.

(5) The first to fourth extended conductors may be disposed between the first spiral conductor and the second spiral conductor in a direction in which the insulating layers are stacked.

(6) The first to fourth extended conductors may be disposed outside of the spiral conductors in a direction in which the insulating layers are stacked.

(7) The first and second spiral conductors each may include conductors disposed on two or more insulating layers and electrically connected to each other.

(8) The conductors of the first spiral conductor and the conductors of the second spiral conductor may be alternately arranged.

(9) The electronic component may have the structure in which the external conductors further include a fifth external electrode and a sixth external electrode each disposed on an external surface of the body, the spiral conductor further includes a third spiral conductor, and the extended conductors further include a fifth extended conductor and a sixth extended conductor disposed within the body. One end portion of the third spiral conductor is electrically connected to the fifth external electrode with the fifth extended conductor therebetween and another end portion of the third spiral conductor is electrically connected to the sixth external electrode with the sixth extended conductor therebetween. The third spiral conductor is disposed on an insulating layer different from an insulating layer on which the fifth and sixth extended conductors are disposed, different from the insulating layer on which the first spiral conductor is disposed, and different from the insulating layer on which the second spiral conductor is disposed. The first spiral conductor and the third spiral conductor are magnetically coupled to each other. The second spiral conductor and the third spiral conductor are magnetically coupled to each other.

(10) The first to sixth extended conductors may be disposed on the same insulating layer.

(11) The first to sixth extended conductors may be disposed between the first spiral conductor and the second spiral conductor, and/or between the second spiral conductor and the third spiral conductor, and/or between the third spiral conductor and the first spiral conductor in a direction in which the insulating layers are stacked.

(12) The first to sixth extended conductors may be disposed outside of the spiral conductors in a direction in which the insulating layer are stacked.

(13) The first to third spiral conductors each may include conductors disposed on two or more insulating layers and electrically connected to each other.

(14) The body may further include a magnetic layer mainly containing ferrite on at least one side in a direction in which the insulating layers are stacked.

(15) The proportion of the at least one oxide selected from the group consisting of Al₂O₃, SiO₂, ZnO, TiO₂, and ZrO₂ in the spiral conductor may be in the range of about 0.1% by mass to 5.0% by mass relative to the total mass of the Ag and the at least one oxide.

The electronic component according to the embodiments of the present invention, which includes a spiral conductor and an extended conductor within a body containing glass, has both reliability in insulation and reliability in connection with external electrodes because the spiral conductor contains Ag and at least one oxide selected from the group consisting of Al₂O₃, SiO₂, ZnO, TiO₂, and ZrO₂, while the extended conductor contains Ag but none of Al₂O₃, SiO₂, ZnO, TiO₂, and ZrO₂.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 is an external perspective view of an electronic component according to an embodiment of the present invention.

FIG. 2 is a schematic exploded perspective view of an electronic component according to a first embodiment of the present invention.

FIG. 3 is a schematic exploded perspective view of an electronic component according to a second embodiment of the present invention.

FIG. 4 is a schematic exploded perspective view of an electronic component according to a third embodiment of the present invention.

FIG. 5 is a schematic exploded perspective view of an electronic component according to a fourth embodiment of the present invention.

FIG. 6 is a schematic exploded perspective view of an electronic component according to a fifth embodiment of the present invention.

FIG. 7 is a schematic exploded perspective view of an electronic component according to a sixth embodiment of the present invention.

FIG. 8 is a plot of the incidence of short-circuiting between the primary coil and the secondary coil of a common mode choke coil with the Al₂O₃ content in the conductor material.

FIG. 9 is a plot of the thickness of a glass coating formed at an end portion of an extended conductor after firing in the manufacturing process of the common mode choke coils of Example 1 and Comparative Example 2.

### DETAILED DESCRIPTION

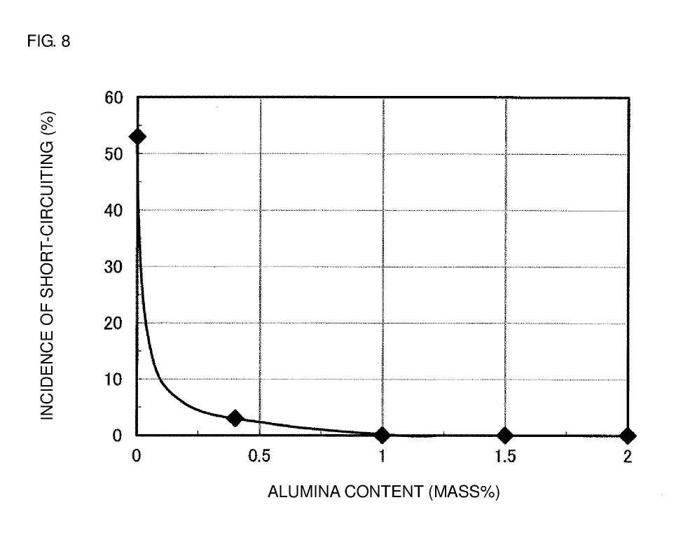

In an attempt to reduce diffusion of Ag into glass in common mode choke coils including a spiral conductor (spiral-shaped conductor) and an extended conductor, each containing Ag and disposed on a glass-containing insulating layer, the present inventors added an oxide selected from the group consisting of Al₂O₃, SiO₂, ZnO, TiO₂, and ZrO₂ (hereinafter referred to as oxides, such as Al₂O₃, in some cases), in addition to Ag, into the spiral conductor and the extended conductor. As a result, it was confirmed that the addition of the oxide into the Ag-containing conductors reduces diffusion of Ag. For chip inductors including a single coil, suppression of Ag diffusion minimizes the decrease in insulation resistance between adjacent conductors of the spiral conductor and, accordingly, to an improved insulation reliability. For common mode choke coils, suppression of Ag diffusion minimizes not only the decrease in insulation resistance between adjacent conductors of the spiral conductor, but also the incidence of short-circuiting and the decrease in insulation resistance between the primary coil and the secondary coil, thus leading to an improved insulation reliability (see the Table and FIG. 8).

The present inventors, however, found that if an oxide, such as Al₂O₃, is added to both the Ag-containing spiral conductor and the Ag-containing extended conductor, the added oxide concentrates at an end portion of the extended conductor (at which a connection to the external conductor will be established) during firing in the manufacturing process of the electronic component. The present inventors also found that if temperature increases, the oxide concentrated at the end portion of the extended conductor draws the constituents of the glass in the insulating layer, such as SiO₂, Al₂O₃, and K₂O, to form a glass coating over the end portion of the extended conductor. The glass coating formed over the end portion of the extended conductor reduces the connection reliability between the extended conductor and the external electrode. These findings suggest that forming both the spiral conductor and the extended conductor of a material containing Ag and an oxide, such as Al₂O₃, makes it difficult to ensure a high reliability in connection between the extended conductor and the external electrode.

Accordingly, the present inventors formed a spiral conductor of a material containing Ag and an oxide selected from the group consisting of Al₂O₃, SiO₂, ZnO, TiO₂, and ZrO₂ and an extended conductor of a material containing Ag but none of Al₂O₃, SiO₂, ZnO, TiO₂, and ZrO₂. Such combination of the spiral conductor and the extended conductor ensured a high reliability in connection between the extended conductor and the external electrode and reduced the diffusion of Ag into the glass.

The present disclosure is based on the above-described findings of the present inventors and provides an electronic component including a body containing glass, a spiral conductor containing Ag and at least one oxide selected from the group consisting of Al₂O₃, SiO₂, ZnO, TiO₂, and ZrO₂, and an extended conductor containing Ag but none of Al₂O₃, SiO₂, ZnO, TiO₂, and ZrO₂.

The material of the insulating layers of the body may be glass, particularly borosilicate glass (glass containing dominantly silicon dioxide, additionally boron, and optionally one or more other compounds), or a composite material of glass and a Ni—Zn—Cu ferrite mainly containing Fe₂O₃, NiO, ZnO, and CuO.

The proportion of the one or more oxides selected from the group consisting of Al₂O₃, SiO₂, ZnO, TiO₂, and ZrO₂ in the spiral conductor is in the range of about 0.1% by mass to 5.0% by mass, preferably about 0.5% by mass to 5.0% by mass, and more preferably about 1.0% by mass to 2.0% by mass, relative to the total mass of Ag and the one or more oxides. When the proportion of the one or more oxides is about 0.1% by mass or more, the diffusion of Ag into glass can be suppressed; when it exceeds about 5.0% by mass, the viscosity of the paste for forming electrodes increases. Such paste is not easily formed into the spiral conductor, and reduces the conductivity of the resulting spiral conductor because of the increased proportion of the oxide, which is electrically insulative.

The phrase “containing none of Al₂O₃, SiO₂, ZnO, TiO₂, and ZrO₂” or similar expression used herein implies that the content thereof is less than 0.1% by mass being the detection limit of the analysis when quantitatively analyzed by wavelength dispersive X-ray spectroscopy (WDX) under the following conditions:

Analyzer: wavelength dispersive X-ray microanalyzer

Accelerating voltage: 15.0 kV

Field of view: 50 μm×50 μm

(250 points×250 points, each 0.2 μm in size)

Irradiation current: 5×10⁻⁸ A

More specifically, the presence of Ag was observed in the insulating layers around the end portion of the conductor containing Ag but no Al₂O₃ by the WDX, compared with the case of the conductor containing Al₂O₃ in addition to Ag. This suggests that Ag in the conductor not containing Al₂O₃ is diffused into the insulating layer by firing in the manufacturing process of the electronic component. When the conductor contained Al₂O₃ in addition to Ag, on the other hand, Ag was not present beyond the detection limit in the insulating layers around the end portion of the conductor; hence, the diffusion of Ag into the insulating layers was suppressed. When Al₂O₃ was replaced with SiO₂, ZnO, TiO₂, or ZrO₂, similar results were obtained.

Also, an extended conductor containing Al₂O₃ in addition to Ag was observed by the WDX during firing in the manufacturing process of the electronic component. As a result, only Al beyond the detection limit was observed around the end portion of the extended conductor. This suggests that Al₂O₃ in the conductor concentrates at the end portion. When the extended conductor was further observed after firing performed at a higher temperature, the presence of Si, Al, and K with high contents was observed around the end portion of the extended conductor. These results suggest that the oxide, such as Al₂O₃, that has concentrated at the end portion of the extended conductor draws the constituents of the glass, such as SiO₂, Al₂O₃, and K₂O, in the insulating layers to form a glass coating over the end portion of the extended conductor. The glass coating formed over the end portion of the extended conductor reduces the reliability in connection between the extended conductors and the external electrode. When Al₂O₃ was replaced with SiO₂, ZnO, TiO₂, or ZrO₂, similar results were obtained.

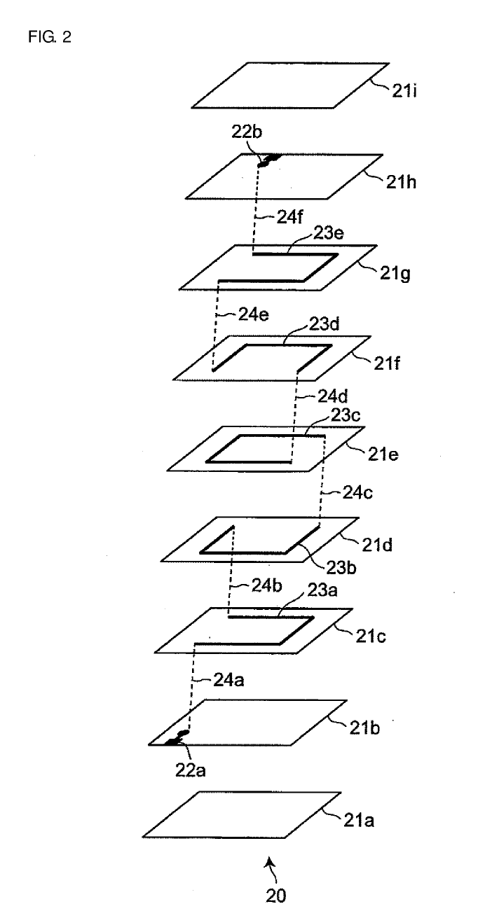

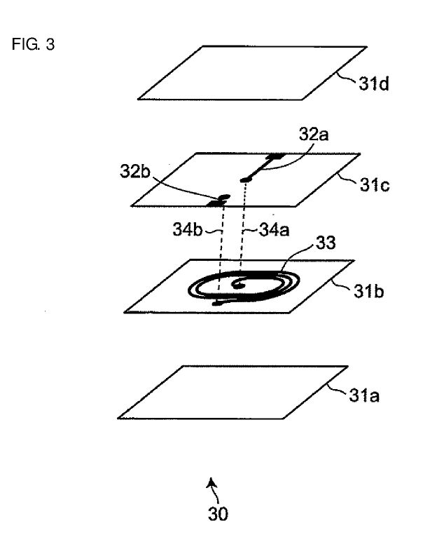

The “spiral conductor” used herein refers to a conductor in a simple spiral form or a non-rounded spiral form and may be constituted by a plurality of spiral patterns disposed on different insulating layers and electrically connected to each other with VIAs therebetween as shown in FIG. 2, without being limited to the form present on a single insulating layer as shown in FIGS. 3 to 7.

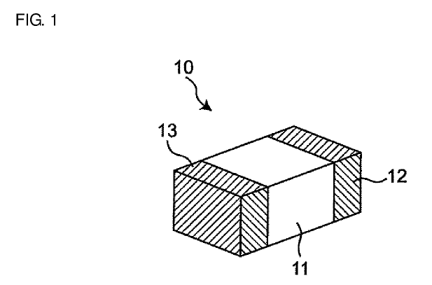

Electronic components according to some embodiments of the present disclosure will now be described with reference to the drawings. FIG. 1 is an external perspective view of an electronic component of an exemplary embodiment of the present invention. As shown in FIG. 1, the electronic component 10 includes a body 11, a first external electrode 12 disposed on one of opposing end faces of the body 11, and a second external electrode 13 disposed on the other end face. The first external electrode 12 and the second external electrode 13 shown in FIG. 1 are what are called five-face electrodes. The first external electrode 12 covers one of the opposing end faces of the body 11 and portions of the upper and the lower faces and opposing side faces extending from that end face and adjacent to that end face. Similarly, the second external electrode 13 covers the other end face of the body 11 and portions of the upper and the lower faces and opposing side faces extending from the other end face and adjacent to the other end face. In the embodiment shown in FIG. 1, the first external electrode 12 is disposed on one of the opposing end faces perpendicular to the longer axis of the body 11, and the second external electrode 13 is disposed on the other end face. In other embodiments, the external electrodes may be disposed on the side faces parallel to the longer axis of the body 11 or on one of the end faces and the side face adjacent to the end face, without being limited to the foregoing structure.

FIGS. 2 to 7 are schematic exploded perspective views of electronic components according to a first to a sixth embodiment of the present invention. The electronic components 20 to 70 shown in FIGS. 2 to 7 each include a body including a plurality of insulating layers stacked, a plurality of external electrodes (not shown) on the external surface of the body, and a spiral conductor and extended conductors that are disposed within the body. The spiral conductor is connected to the external electrodes with the extended conductors therebetween. The spiral conductor contains Ag and at least one oxide selected from the group consisting of Al₂O₃, SiO₂, ZnO, TiO₂, and ZrO₂, and the extended conductors contain Ag but none of Al₂O₃, SiO₂, ZnO, TiO₂, and ZrO₂. Desirably, each of the insulating layers has a thickness in the range of about 7 μm to 35 μm, preferably in the range of about 14 μm to 28 μm. Desirably, the spiral conductor has a line width in the range of about 7 μm to 35 μm, preferably in the range of about 10 μm to 24 μm, and a line spacing in the range of about 7 μm to 35 μm, preferably in the range of about 10 μm to 24 μm.

The electronic components of the first to sixth embodiments will now be described in detail with reference to the drawings. In the following description, a plurality of spiral conductors and a plurality of extended conductors each may be designated as a/the n-th spiral conductor or a/the n-th extended conductor (n is an integer of 1 or more). In this instance, the n-th spiral conductor contains Ag and at least one oxide selected from the group consisting of Al₂O₃, SiO₂, ZnO, TiO₂, and ZrO₂, and the n-th extended conductor contains Ag but none of Al₂O₃, SiO₂, ZnO, TiO₂, and ZrO₂.

### First Embodiment

An electronic component 20 according to a first embodiment is embodied as a chip inductor, and includes a 1st to a 9th insulating layer 21a to 21i, as shown in FIG. 2. A 1st extended conductor 22a is disposed on the 2nd insulating layer 21b, and a 2nd extended conductor 22b is disposed on the 8th insulating layer 21h. U-shaped spiral patterns 23a to 23e are each disposed on one of the 3rd to 7th insulating layers 21c to 21g. The first extended conductor 22a and a spiral pattern 23a are electrically connected to each other with a VIA (vertical interconnect access) 24a formed in the 3rd insulating layer 21c. Similarly, spiral patterns 23a and 23b are electrically connected to each other with a VIA 24b formed in the 4th insulating layer 21d; spiral patterns 23b and 23c are electrically connected to each other with a VIA 24c formed in the 5th insulating layer 21e; spiral patterns 23c and 23d are electrically connected to each other with a VIA 24d formed in the 6th insulating layer 21f; spiral patterns 23d and 23e are electrically connected to each other with a VIA 24e formed in the 7th insulating layer 21g; and a spiral pattern 23e and the 2nd extended conductor 22b are electrically connected to each other with a VIA 24f formed in the 8th insulating layer 21h. The body (not shown) including the stacked 1st to 9th insulating layers 21a to 21i is provided with a 1st external electrode on one of the opposing side faces parallel to the longer axis of the body (on the front side in FIG. 2), and with a second external electrode on the other side face. The 1st extended conductor 22a is electrically connected to the 1st external electrode, and the 2nd extended conductor 22b is electrically connected to the 2nd external electrode.

In the electronic component of the first embodiment, the spiral patterns 23a to 23e are electrically connected to one another with VIAs 24b to 24e. Thus, the spiral patterns 23a to 23e and the VIAs 24b to 24e constitute a single spiral conductor. One of the end portions of the spiral conductor is electrically connected to the 1st extended conductor 22a, and the other is electrically connected to the 2nd extended conductor 22b.

The electronic component 20 having such a structure can be manufactured by forming the spiral patterns on the respective insulating layers by, for example, screen printing, stacking the insulating layers, and firing the stack of the insulating layers. In the electronic component of the first embodiment, the reliability in connection between the extended conductors and the external conductors is enhanced without reducing insulation resistance (IR) during firing. More specifically, the presence of Ag and one or more oxides, such as Al₂O₃, in the spiral conductor suppresses the diffusion of Ag into glass during firing in the manufacturing process of the electronic component, and the combination of the presence of Ag and the absence of oxides, such as Al₂O₃, in the extended conductors prevents the formation of a glass coating over the end portions of the extended conductors during firing. Accordingly, the insulation resistance (IR) between any adjacent spiral patterns of the spiral conductor can be kept high, and the reliability in connection between the extended conductors and the external conductors can be enhanced. The stack of the insulating layers is typically fired at a temperature in the range of about 800° C. to 950° C. for a period in the range of about 30 min to 150 min.

### Second Embodiment

An electronic component 30 according to a second embodiment is embodied as a chip inductor having a different structure from the chip inductor of the first embodiment, and includes a 1st to a 4th insulating layer 31a to 31d, as shown in FIG. 3. A 1st extended conductor 32a and a 2nd extended conductor 32b are disposed on the 3rd insulating layer 31c, and a spiral conductor 33 is disposed on the 2nd insulating layer 31b. One of the end portions of the spiral conductor 33 is electrically connected to the 1st extended conductor 32a with a VIA 34a formed in the 3rd insulating layer 31c, and the other is electrically connected to the 2nd extended conductor 32b with a VIA 34b formed in the 3rd insulating layer 31c. The body (not shown) including the stacked 1st to 4th insulating layers 31a to 31d is provided with a 2nd external electrode on one of the opposing side faces parallel to the longer axis of the body (on the front side in FIG. 3), and with a 1st external electrode on the other side face. The 1st extended conductor 32a is electrically connected to the first external electrode, and the 2nd extended conductor 32b is electrically connected to the 2nd external electrode.

The electronic component 30 having such a structure can be manufactured by forming the 1st extended conductor 32a and the 2nd extended conductor 32b on the 3rd insulating layer 31c by, for example, screen printing, forming the spiral conductor on the 2nd insulating layer 31b by, for example, screen printing, and firing a stack of all the insulating layers. In the electronic component 30 of the second embodiment, the reliability in connection between the extended conductors and the external conductors is enhanced without reducing insulation resistance (IR) between two-dimensionally adjacent portions of the spiral conductor 33.

### Third Embodiment

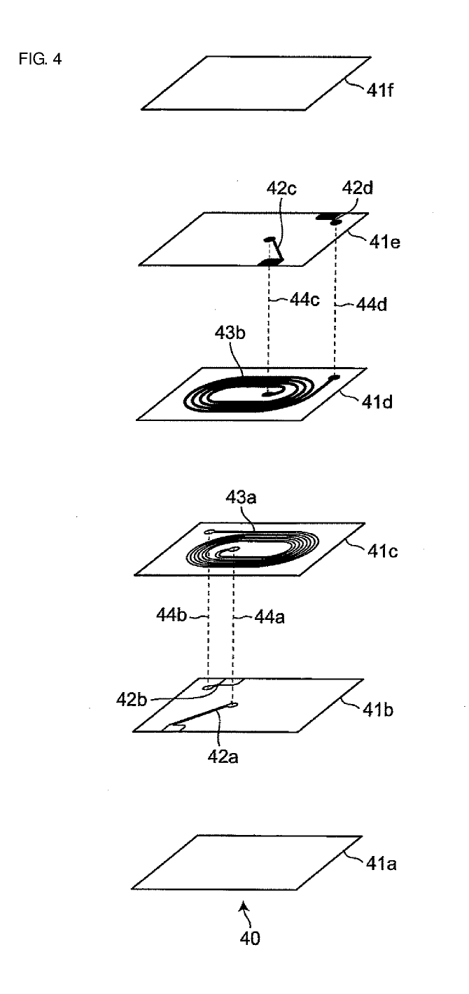

An electronic component 40 according to a third embodiment is embodied as a common mode choke coil, and includes a 1st to a 6th insulating layer 41a to 41f, as shown in FIG. 4. A 1st extended conductor 42a and a 2nd extended conductor 42b are disposed on the 2nd insulating layer 41b, and a 3rd extended conductor 42c and a 4th extended conductor 42d are disposed on the 5th insulating layer 41e. A 1st spiral conductor 43a (primary coil) is disposed on the 3rd insulating layer 41c, and a 2nd spiral conductor 43b (secondary coil) is disposed on the 4th insulating layer 41d. One of the end portions of the 1st spiral conductor 43a is electrically connected to the 1st extended conductor 42a with a VIA 44a formed in the 3rd insulating layer 41c, and the other is electrically connected to the 2nd extended conductor 42b with a VIA 44b formed in the 3rd insulating layer 41c. Similarly, one of the end portions of the 2nd spiral conductor 43b is electrically connected to the 3rd extended conductor 42c with a VIA 44c formed in the 5th insulating layer 41e, and the other is electrically connected to the 4th extended conductor 42d with a VIA 44d formed in the 5th insulating layer 41e. The body (not shown) including the stacked 1st to 6th insulating layers 41a to 41f is provided with a 1st and a 2nd external electrode on one of the opposing side faces parallel to the longer axis of the body (on the front side in FIG. 4), and with a 3rd and a 4th external electrode on the other side face. The 1st extended conductor 42a is electrically connected to the 1st external electrode; the 2nd extended conductor 42b is electrically connected to the 3rd external connected to the 2nd external electrode; and the 4th extended conductor 42d is electrically connected to the 4th external electrode. The 1st spiral conductor 43a and the 2nd spiral conductor 43b oppose each other with the 4th insulating layer 41d therebetween and are magnetically coupled.

The electronic component 40 having such a structure can be manufactured by forming the 1st extended conductor 42a and the 2nd extended conductor 42b on the 2nd insulating layer 41b, the 3rd extended conductor 42c and the 4th extended conductor 42d on the 5th insulating layer 41e, the 1st spiral conductor 43a on the 3rd insulating layer 41c, and the 2nd spiral conductor 43b on the 4th insulating layer 41d by, for example, screen printing, and firing a stack of all the insulating layers. In the electronic component 40 of the third embodiment, the 1st and the 2nd spiral conductor 43a and 43b contain one or more oxides, such as Al₂O₃, in addition to Ag. This suppresses the diffusion of Ag into glass during firing in the manufacturing process of the electronic component. Consequently, a decrease in insulation resistance between the 1st spiral conductor 43a and the 2nd spiral conductor 43b is minimized. In addition, the reliability of connection between the extended conductors and the corresponding external conductors is enhanced without reducing insulation resistance (IR) during firing, as in the first to third embodiments.

### Fourth Embodiment

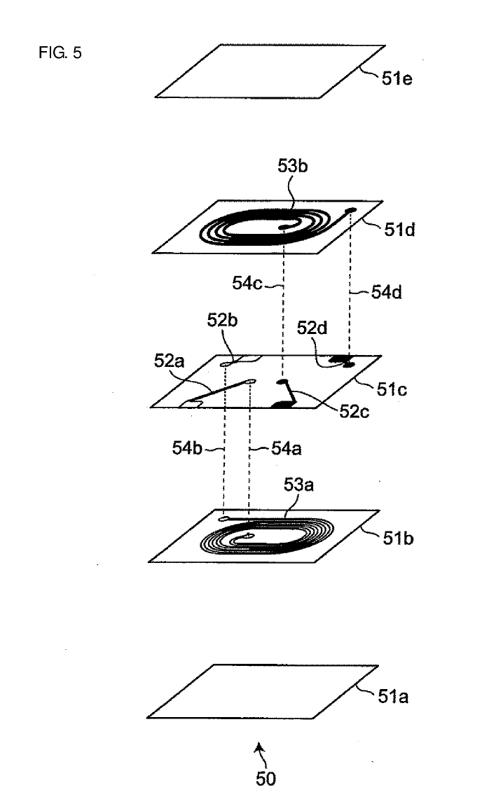

An electronic component 50 according to a fourth embodiment is a common mode choke coil having different extended conductors from the electronic component 40 of the third embodiment in terms of the following two points: (a) all of the four extended conductors, a 1st to a 4th extended conductor 52a to 52d, are disposed together on a single 3rd insulating layer 51c; and (b) the 3rd insulating layer 51c having the four 1st to 4th extended conductors 52a to 52d thereon is disposed between a 2nd insulating layer 51b having a 1st spiral conductor 53a (primary coil) thereon and a 4th insulating layer 51d having a 2nd spiral conductor 53b (secondary coil) thereon, as shown in FIG. 5. One of the end portions of the 1st spiral conductor 53a is electrically connected to the 1st extended conductor 52a with a VIA 54a formed in the 3rd insulating layer 51c, and the other is electrically connected to the 2nd extended conductor 52b with a VIA 54b formed in the 3rd insulating layer 51c. Similarly, one of the end portions of the 2nd spiral conductor 53b is electrically connected to the 3rd extended conductor 52c with a VIA 54c formed in the 4th insulating layer 51d, and the other is electrically connected to the 4th extended conductor 52d with a VIA 54d formed in the 4th insulating layer 51d. The body (not shown) including the stacked 1st to 5th insulating layers 51a to 51e is provided with a 1st and a 2nd external electrode on one of the opposing side faces parallel to the longer axis of the body (on the front side in FIG. 5), and with a 3rd and a 4th external electrode on the other side face. The 1st extended conductor 52a is electrically connected to the 1st external electrode; the 2nd extended conductor 52b is electrically connected to the 3rd external electrode; the 3rd extended conductor 52c is electrically connected to the 2nd external electrode; and the 4th extended conductor 52d is electrically connected to the 4th external electrode. The 1st spiral conductor 53a and the 2nd spiral conductor 53b oppose each other with the 3rd and 4th insulating layers 51c and 51d therebetween and are magnetically coupled.

The electronic component 50 of the fourth embodiment having such a structure produces the same effect as in the third embodiment. In addition, the structure of this embodiment allows simultaneous formation of all of the four 1st to 4th extended conductors 52a to 52d together on the single 3rd insulating layer 51c by printing or the like and a reduction of the number of insulating layers, resulting in a reduced manufacturing cost. The arrangement in which the 3rd insulating layer 51c having the 1st to 4th extended conductors 52a to 52d thereon is located between the 1st spiral conductor 53a (primary coil) and the 2nd spiral conductor 53b (secondary coil) provides a larger distance between the 1st spiral conductor 53a (primary coil) and the 2nd spiral conductor 53b (secondary coil), and, accordingly, reduces the stray capacitance generated between the spiral conductors, resulting in improved signal transmission.

### Modification of Fourth Embodiment

Although, in the fourth embodiment, the insulating layer 51c having the 1st to 4th extended conductors 52a to 52d thereon is located between the 1st spiral conductor 53a (primary coil) and the 2nd spiral conductor 53b (secondary coil), the insulating layer 51c having the 1st to 4th extended conductors 52a to 52d thereon may be located outside the portion between the spiral conductors and adjacent to the 1st spiral conductor 53a (primary coil) or the 2nd spiral conductor 53b (secondary coil). In this instance, the distance between the two spiral conductors, that is, the 1st spiral conductor 53a (primary coil) and the 2nd spiral conductor 53b, can be reduced, and accordingly, the magnetic coupling therebetween can be enhanced. As described above, the common mode choke coil according to the electronic component of the fourth embodiment may be modified in a variety of ways according to the specifications required.

### Fifth Embodiment

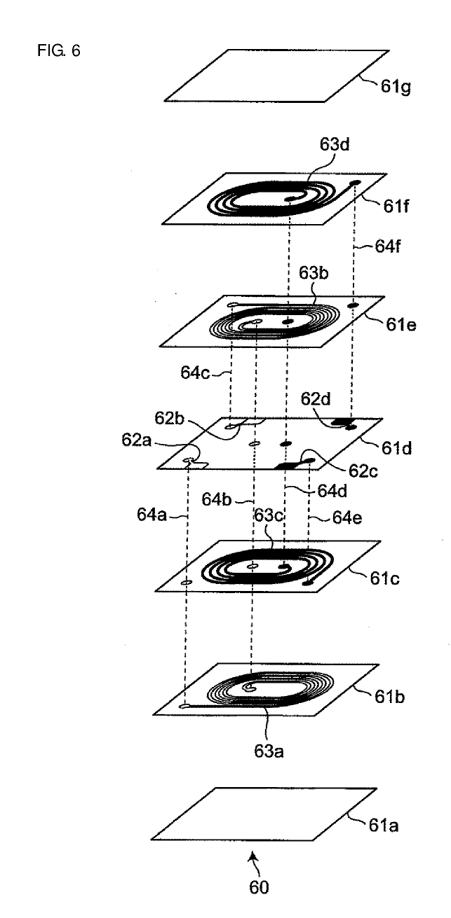

An electronic component according to a fifth embodiment is a common mode choke coil including a first spiral conductor including two spiral conductors that are connected to each other with a VIA formed in one or more insulating layers and a second spiral conductor including two spiral conductors that are connected to each other with a VIA formed in one or more insulating layers, as shown in FIG. 6. More specifically, the electronic component 60 of the fifth embodiment includes a 1st to a 7th insulating layer 61a to 61g, and in which a 1st extended conductor 62a, a 2nd extended conductor 62b, a 3rd extended conductor 62c, and a 4th extended conductor 62d are disposed on the 4th insulating layer 61d located at the center of the structure, as shown in FIG. 6. A 1st-A spiral conductor 63a is disposed on the 2nd insulating layer 61b, and a 1st-B spiral conductor 63b is disposed on the 5th insulating layer 61e. The 1st-A spiral conductor 63a and the 1st-B spiral conductor 63b are connected to each other at each one end portion with a VIA 64b continuously passing through insulating layers 61e, 61d, and 61c, thus defining the 1st spiral conductor (primary coil). The other end portion of the 1st-A spiral conductor 63a is connected to the 1st extended conductor 62a with a VIA 64a continuously passing through insulating layers 61c and 61d, and the other end portion of the 1st-B spiral conductor 63b is connected to the 2nd extended conductor 62b with a VIA 64c formed in the insulating layer 61e. Thus, the first spiral conductor (primary coil) is connected to the 1st extended conductor 62a and the 2nd extended conductor 62b.

A 2nd-C spiral conductor 63c is disposed on the 3rd insulating layer 61c, and a 2nd-D spiral conductor 63d is disposed on the 6th insulating layer 61f. The 2nd-C spiral conductor 63c and the 2nd-D spiral conductor 63d are connected to each other at each one end portion with a VIA 64d continuously passing through insulating layers 61d, 61e, and 61f, thus defining the 2nd spiral conductor (secondary coil). The other end portion of the 2nd-C spiral conductor 63c is connected to the 3rd extended conductor 62c with a VIA 64e formed in the insulating layer 61d, and the other end portion of the 2nd-D spiral conductor 63d is connected to the 4th extended conductor 62d with a VIA 64f continuously passing through insulating layers 61e and 61f. Thus, the second spiral conductor (secondary coil) is connected to the 3rd extended conductor 62c and the 4th extended conductor 62d. The body (not shown) including the stacked 1st to 7th insulating layers 61a to 61g is provided with a 1st and a 2nd external electrode on one of the opposing side faces parallel to the longer axis of the body (on the front side in FIG. 6), and with a 3rd and a 4th external electrode on the other side face. The 1st extended conductor 62a is electrically connected to the 1st external electrode; the 2nd extended conductor 62b is electrically connected to the 3rd external electrode; the 3rd extended conductor 62c is electrically connected to the 2nd external electrode; and the 4th extended conductor 62d is electrically connected to the 4th external electrode.

The electronic component 60 of the fifth embodiment having such a structure produced the same effect as the electronic component of the third embodiment. In the electronic component of the fifth embodiment, the 2nd-C spiral conductor 63c that is a portion of the 2nd spiral conductor is located between the 1st-A and the 1st-B spiral conductor 63a and 63b of the 1st spiral conductor, and the 1st-B spiral conductor 63b that is a portion of the 1st spiral conductor is located between the 2nd-C and the 2nd-D spiral conductor 63c and 63d of the 2nd spiral conductor. In other words, in the electronic component of the fifth embodiment, the elements of the 1st spiral conductor, each of which is a portion of the first spiral conductor, and the elements of the second spiral conductor, each of which is a portion of the second spiral conductor, are alternately arranged. Thus, the magnetic coupling between the 1st spiral conductor (primary coil) and the 2nd spiral conductor (secondary coil) can be enhanced, and the stray capacitance therebetween can be reduced. In addition, the structure of the 1st and the 2nd spiral conductor, each including a plurality of spiral conductor layers, increases the line length of each of the 1st and the 2nd spiral conductor, thus increasing common mode impedance (Zc).

### Modification 1 of Fifth Embodiment

In the electronic component 60 of the fifth embodiment, the insulating layer 61d having the four extended conductors 62a to 62d thereon is located between the insulating layer 61c having thereon the 2nd-C spiral conductor 63c that is a portion of the secondary coil and the insulating layer 61e having thereon the 1st-B spiral conductor 63b that is a portion of the primary coil, as described above. The fifth embodiment is, however, not limited to this structure and may be modified into a structure in which the insulating layer having the extended conductors thereon is located outside the portion defined by the insulating layers having the spiral conductors constituting the primary coil and the spiral conductors constituting the secondary coil. This arrangement allows the spiral conductors constituting the primary coil and the spiral conductors constituting the secondary coil to be arranged close to each other, consequently enhancing the magnetic coupling between the primary coil and the secondary coil.

### Modification 2 of Fifth Embodiment

In the electronic component 60 of the fifth embodiment, the 1st spiral conductor (primary coil) and the 2nd spiral conductor (secondary coil) are each constituted of two spiral conductors. The fifth embodiment is, however, not limited to this structure and may be modified into a structure in which the 1st spiral conductor (primary coil) and the 2nd spiral conductor (secondary coil) are each constituted of three or more spiral conductors. This structure increases the line length of each of the 1st spiral conductor (primary coil) and the 2nd spiral conductor (secondary coil), consequently further increasing common mode impedance (Zc).

### Modification 3 of Fifth Embodiment

Modifications 1 and 2 of the fifth embodiment may be combined into a structure in which the 1st spiral conductor (primary coil) and the 2nd spiral conductor (secondary coil) are each constituted of three or more spiral conductor layers disposed on the respective insulating layers adjacent to each other while the insulating layer having the extended conductors thereon is disposed outside the portion defined by the insulating layers having the spiral conductors.

### Sixth Embodiment

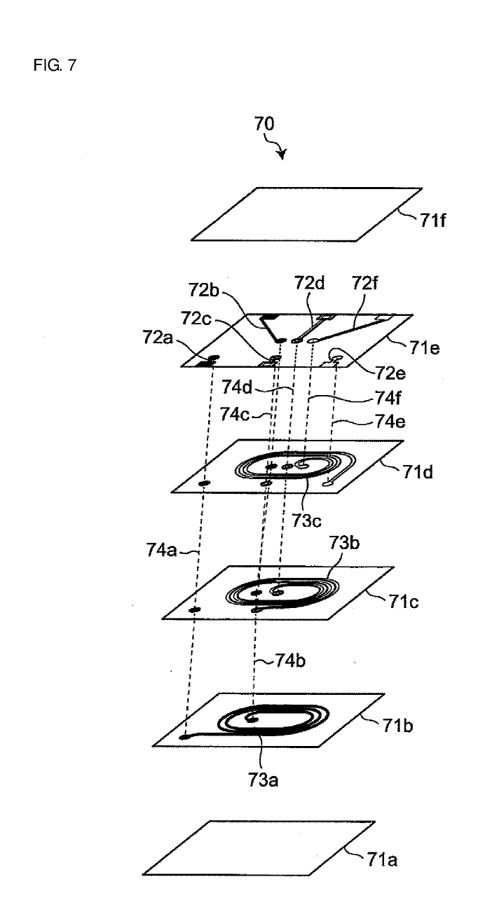

An electronic component 70 according to a sixth embodiment is a three-line common mode choke coil having a primary, a secondary, and a tertiary coil, and includes a 1st to a 6th insulating layer 71a to 71f as shown in FIG. 7. The 5th insulating layer 71e that is one of the insulating layers is provided thereon with a 1st and a 2nd extended conductor 72a and 72b connected to the primary coil, a 3rd and a 4th extended conductor 72c and 72d connected to the secondary coil, and a 5th and a 6th extended conductor 72e and 72f connected to the tertiary coil. A 1st spiral conductor 73a defining the primary coil is disposed on the 2nd insulating layer 71b; a 2nd spiral conductor 73b defining the secondary coil is disposed on the 3rd insulating layer 71c; and a 3rd spiral conductor 73c defining the tertiary coil is disposed on the 4th insulating layer 71d. One of the end portions of the 1st spiral conductor 73a is electrically connected to the 1st extended conductor 72a with a VIA 74a passing continuously through the 3rd to 5th insulating layers 71c, 71d, and 71e, and the other is electrically connected to the 2nd extended conductor 72b with a VIA 74b passing continuously through the 3rd to 5th insulating layers 71c, 71d, and 71e. One of the end portions of the 2nd spiral conductor 73b is electrically connected to the 3rd extended conductor 72c with a VIA 74c passing through the 4th and 5th insulating layers 71d and 71e, and the other is electrically connected to the 4th extended conductor 72d with a VIA 74d passing through the 4th and 5th insulating layers 71d and 71e. Similarly, one of the end portions of the 3rd spiral conductor 73c is electrically connected to the 5th extended conductor 72e with a VIA 74e formed in the 5th insulating layer 71e, and the other is electrically connected to the 6th extended conductor 72f with a VIA 74f formed in the 5th insulating layer 71e. The body (not shown) including the stacked 1st to 7th insulating layers 71a to 71f is provided with a 1st, a 3rd, and a 5th external electrode on one of the opposing side faces parallel to the longer axis of the body (on the front side in FIG. 7), and with a 2nd, a 4th, and a 6th external electrode on the other side face. The 1st extended conductor 72a is electrically connected to the 1st external electrode; the 2nd extended conductor 72b is electrically connected to the 2nd external electrode; the 3rd extended conductor 72c is electrically connected to the 3rd external electrode; the 4th extended conductor 72d is electrically connected to the 4th external electrode; the 5th extended conductor 72e is electrically connected to the 5th external electrode; and the 6th extended conductor 72f is electrically connected to the 6th external electrode.

The 1st spiral conductor 73a (primary coil) and the adjacent 2nd spiral conductor 73b (secondary coil) are magnetically coupled, and the 2nd spiral conductor 73b (secondary coil) and the adjacent 3rd spiral conductor 73c (tertiary coil) are magnetically coupled. Thus, the electronic component 70 of the sixth embodiment is embodied as a three-line common mode choke coil.

The electronic component 70 of the sixth embodiment having such a structure produced the same effect as in the third embodiment.

### Modification 1 of Sixth Embodiment

In the electronic component of the sixth embodiment, the 4th insulating layer 71e having the six 1st to 6th extended conductors 72a, 72b, 72c, 72d, 72e, and 72f thereon is located on the outer side of the insulating layer 71d having the 3rd spiral conductor 73c thereon. The sixth embodiment is however not limited to this structure and may be modified in such a manner that the 4th insulating layer having the 1st to 6th extended conductors 72a, 72b, 72c, 72d, 72e, and 72f thereon is located between the 1st spiral conductor 73a and the 2nd spiral conductor 73b or between the 2nd spiral conductor 73b and the 3rd spiral conductor 73c. This arrangement in which the insulating layer having the extended conductors thereon is disposed between any two of the spiral conductors can increase the distance between the spiral conductors to reduce the stray capacitance between the spiral conductors.

The electronic component of the sixth embodiment, in which the six extended conductors 72a, 72b, 72c, 72d, 72e, and 72f are disposed together on the single insulating layer 71e of the insulating layers, is not limited to this structure and may be modified in such a manner that the six extended conductors 72a, 72b, 72c, 72d, 72e, and 72f are disposed separately on two or more insulating layers. If the six extended conductors 72a, 72b, 72c, 72d, 72e, and 72f are disposed separately on two or more insulating layers, the two or more insulating layers may be located outside the portion defined by the insulating layers having the 1st to 3rd spiral conductors 73a to 73c, or between the 1st and the 2nd spiral conductor 73a and 73b or between the 2nd and the 3rd spiral conductor 73b and 73c.

### Modification 2 of Sixth Embodiment

Although the primary coil, the secondary coil, and the tertiary coil of the electronic component 70 of the sixth embodiment each include a single spiral conductor, at least one of the primary coil, the secondary coil, and the tertiary coil may include two or more spiral conductors, or all the coils may be include two or more spiral conductors.

As described above, the three-line common mode choke coil of the sixth embodiment may be modified in a variety of ways according to the required properties and specifications.

### EXAMPLES

The present disclosure will be further described in detail with reference to some Examples, but it is not limited to the following Examples.

### Example 1

An electronic component having the structure shown in in FIG. 4 was produced. The electronic component included the following members or materials having the following dimensions.

Insulating layer 41a: Ni—Cu—Zn ferrite

Insulating layers 41b to 41f: borosilicate glass

Thickness of the insulating layers: 18 μm

Line width of the spiral conductors: 18 μm

Line spacing of the spiral conductors: 18 μm

First, green sheets of the insulating layers 41a to 41f were prepared. VIA holes are formed in the green sheets of the insulating layers 41c and 41e by laser processing and were then filled with a conductive paste to form VIAs 44a to 44d. Then, conductor patterns of spiral conductors 43a and 43b were screen printed on the green sheets of the insulating layers 41c and 41d, respectively, and conductor patterns of extended conductors 42a, 42b, 42c, and 42d were formed on the green sheets of the corresponding insulating layers 41b and 41e. The green sheets were stacked, and the stack was fired at 900° C. for 120 min to yield a body. Then, the body was chamfered by barrel polishing. After forming external electrodes by baking, the external electrodes were subjected to nickel/tin plating to yield an electronic component.

In this process, for forming the spiral conductors, a conductive paste containing Ag and 1.3% by mass of Al₂O₃ was used. On the other hand, for forming the extended conductors, a conductive paste containing Ag but none of the oxides, such as Al₂O₃, was used.

### Comparative Example 1

An electronic component was produced in the same manner as in Example 1, except that the conductive paste of Example 1 containing Ag but none of the oxides, such as Al₂O₃, was used for forming the spiral conductors.

### Comparative Example 2

An electronic component was produced in the same manner as in Example 1, except that the conductive paste of Example 1 containing Ag and 1.3% by mass of Al₂O₃ was used for forming the extended conductors.

### Comparison of the Incidence of Initial Defects

The electronic components of Example 1 and Comparative Example 1 were examined for the incidence of initial defects in insulation resistance (IR). The results are shown in the Table. The examination was conducted as below.

### Test Procedure

### Insulation Resistance (IR)

A direct current of 5 V was applied between the 1st spiral conductor (primary coil) and the 2nd spiral conductor (secondary coil) of each of the electronic components of Example 1 and Comparative Example 1, and the insulation resistance (IR) at this time was measured with a digital electrometer 8340A (manufactured by Advantest). When the IR was not 10 MΩ or more, it was determined to be defective, and the incidence of defects was calculated (number of samples: n=100,000).

### Results

TABLE

| | Incidence (%) of IR defects |
|---|---|
| Example 1 | 0.61 |
| Comparative Example 1 | 35.72 |

The Table suggests that the electronic component of Example 1, which included spiral conductors containing Ag and Al₂O₃ on insulating layers containing glass and extended conductors containing Ag but no Al₂O₃ on insulating layers containing glass, exhibited a higher insulation reliability and a lower percentage of initial defects in IR than the electronic component of Comparative Example 1, which included spiral conductors containing Ag but no Al₂O₃ and extended conductors containing Ag but no Al₂O₃.

### Glass Coating on End Portion of Extended Conductor

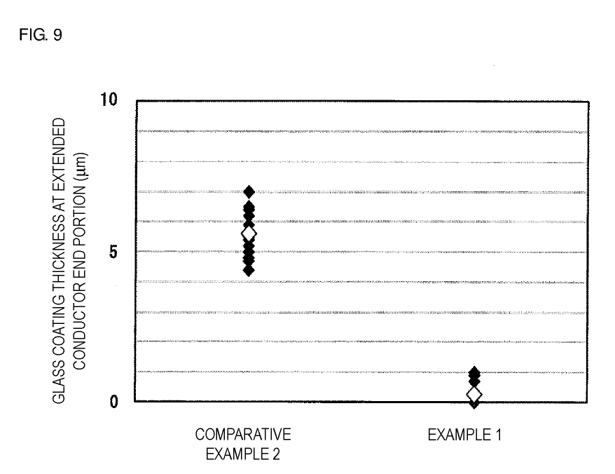

The electronic components of Example 1 and Comparative Example 2 were examined for the thickness of the glass coating formed over an end portion of an extended conductor. The results are shown in FIG. 9.

### Test Procedure

### Thickness of Glass Coating

For measuring the thickness of the glass coating, an end portion of the 1st extended conductor 42a, extracted onto one of the side faces parallel to the longer axis of the body (on the front side in FIG. 4) was measured. More specifically, the body was cut along the portion having the 1st extended conductor 42a in the stacking direction, and the thickness of the glass coating at the section was measured by using the length measuring function of a microscope. FIG. 9 shows the results obtained by measurement for fired bodies (number of samples: n=12, solid diamond: measured value, outline diamond: average).

### Results

FIG. 9 shows that the thickness of the glass coating was about 1 μm or less in Example 1. On the other hand, in Comparative Example 2, the glass coating had a thickness of about 4 μm to 7 μm.

Since the end portions of the extended conductors were ground about 2 μm to 3 μm by barrel polishing after firing, the glass coating on the end portion of the extended conductor on one side face in Example 1 was removed with reliability. Accordingly, the external electrodes were connected to the respective extended conductors with reliability.

Therefore, the electronic component of Example 1, which included spiral conductors containing Ag and Al₂O₃ on insulating layers containing glass and extended conductors containing Ag but no Al₂O₃ on insulating layers containing glass, exhibited a higher connection reliability than the electronic component of Comparative Example 2, which included spiral conductors and extended conductors, each containing Ag and Al₂O₃.

Electronic components produced in the same manner as in Example 1 except that Al₂O₃ was replaced with SiO₂, ZnO, TiO₂, or ZrO₂ exhibited the same tendency. In addition, electronic components having the structures of fourth to sixth embodiments shown in FIGS. 5 to 7 and produced using conductors having the same compositions as in Example 1 also exhibited the same tendency as in Example 1 and high reliability in both insulation and connection with external electrodes.

While preferred embodiments of the disclosure have been described above, it is to be understood that variations and modifications will be apparent to those skilled in the art without departing from the scope and spirit of the invention. The scope of the invention, therefore, is to be determined solely by the following claims.

What is claimed is:

1. An electronic component comprising:
a body containing glass;
external conductors including a first external electrode and a second external electrode each disposed on an external surface of the body;
a spiral conductor disposed within the body; and
extended conductors including a first extended conductor and a second extended conductor each disposed within the body,
wherein one end portion of the spiral conductor is electrically connected to the first external electrode with the first extended conductor therebetween and another end portion of the spiral conductor is electrically connected to the second external electrode with the second extended conductor therebetween, and
wherein the spiral conductor contains Ag and at least one oxide selected from the group consisting of Al₂O₃, SiO₂, ZnO, TiO₂, and ZrO₂, and the extended conductors contain Ag, but none of Al₂O₃, SiO₂, ZnO, TiO₂, and ZrO₂.

2. The electronic component according to claim 1, wherein the body includes a plurality of stacked insulating layers.

3. The electronic component according to claim 2, wherein the spiral conductor is disposed on an insulating layer different from an insulating layer on which the first extended conductor and the second extended conductor are disposed.

4. The electronic component according to claim 3,
wherein the external conductors further include a third external electrode and a fourth external electrode each disposed on an external surface of the body, the spiral conductor includes a first spiral conductor and a second spiral conductor disposed on different insulating layers within the body, and the extended conductors further include a third extended conductor and a fourth extended conductor disposed within the body,
wherein one end portion of the first spiral conductor is electrically connected to the first external electrode with the first extended conductor therebetween and another end portion of the first spiral conductor is electrically connected to the second external electrode with the second extended conductor therebetween, and
wherein one end portion of the second spiral conductor is electrically connected to the third external electrode with the third extended conductor therebetween and another end portion of the second spiral conductor is electrically connected to the fourth external electrode with the fourth extended conductor therebetween, and the second spiral conductor is disposed on an insulating layer different from an insulating layer on which the third extended conductor and the fourth extended conductor are disposed and is magnetically coupled with the first spiral conductor.

5. The electronic component according to claim 4, wherein the first to fourth extended conductors are disposed on the same insulating layer.

6. The electronic component according to claim 4, wherein the first to fourth extended conductors are disposed between the first spiral conductor and the second spiral conductor in a direction in which the insulating layers are stacked.

7. The electronic component according to claim 4, wherein the first to fourth extended conductors are disposed outside of the spiral conductors in a direction in which the insulating layers are stacked.

8. The electronic component according to claim 4, wherein the first and second spiral conductors each include conductors disposed on two or more insulating layers and electrically connected to each other.

9. The electronic component according to claim 8, wherein the conductors of the first spiral conductor and the conductors of the second spiral conductor are alternately arranged.

10. The electronic component according to claim 4,
wherein the external conductors further include a fifth external electrode and a sixth external electrode each disposed on an external surface of the body, the spiral conductor further includes a third spiral conductor, and the extended conductors further include a fifth extended conductor and a sixth extended conductor disposed within the body, and
wherein one end portion of the third spiral conductor is electrically connected to the fifth external electrode with the fifth extended conductor therebetween and another end portion of the third spiral conductor is electrically connected to the sixth external electrode with the sixth extended conductor therebetween, and the third spiral conductor is disposed on an insulating layer different from an insulating layer on which the fifth and sixth extended conductors are disposed, different from the insulating layer on which the first spiral conductor is disposed, and different from the insulating layer on which the second spiral conductor is disposed, and the third spiral conductor is magnetically coupled with the first spiral conductor and magnetically coupled with the second spiral conductor.

11. The electronic component according to claim 10, wherein the first to sixth extended conductors are disposed on a same insulating layer.

12. The electronic component according to claim 10, wherein the first to sixth extended conductors are disposed between the first spiral conductor and the second spiral conductor, and/or between the second spiral conductor and the third spiral conductor, and/or between the third spiral conductor and the first spiral conductor in a direction in which the insulating layers are stacked.

13. The electronic component according to claim 10, wherein the first to sixth extended conductors are disposed outside of the spiral conductors in a direction in which the insulating layers are stacked.

14. The electronic component according to claim 10, wherein the first to third spiral conductors each include conductors disposed on two or more insulating layers and electrically connected to each other.

15. The electronic component according to claim 2, wherein the body further includes a magnetic layer mainly containing ferrite on at least one side in a direction in which the insulating layers are stacked.

16. The electronic component according to claim 1, wherein the proportion of the at least one oxide selected from the group consisting of Al₂O₃, SiO₂, ZnO, TiO₂, and ZrO₂ in the spiral conductor is in the range of about 0.1% by mass to 5.0% by mass relative to the total mass of the Ag and the at least one oxide.
